(19) United States
(12) Patent Application Publication
(10) Pub. No.: US 2012/0153182 A1
(43) Pub. Date: Jun. 21, 2012

(54) RADIATION IMAGE OBTAINING METHOD AND RADIATION IMAGE CAPTURING APPARATUS

(75) Inventor: Naoto IWAKIRI, Ashigarakami-gun (JP)

(73) Assignee: FUJIFILM CORPORATION, Tokyo (JP)

(21) Appl. No.: 13/333,568

(22) Filed: Dec. 21, 2011

(30) Foreign Application Priority Data
Dec. 21, 2010 (JP) 2010/284167
Dec. 16, 2011 (JP) 2011/275581

(51) Int. Cl. G01J 1/42

(52) U.S. Cl. 250/394

(57) ABSTRACT

A radiation image capturing apparatus for capturing a plurality of radiation images by translating a second grid with respect to a first grid and transmitting the plurality of radiation images includes a storage unit for storing a plurality of radiation image signals captured by translating the second grid with respect to the first grid, an association unit for associating the plurality of radiation image signals stored in the storage unit, and a communication unit for transmitting one set of the radiation image signals associated by the association unit at a time.

### BACKGROUND OF THE INVENTION

1. Field of the Invention

The present invention relates to a radiation image obtaining method and a radiation image capturing apparatus using a grid.

2. Description of the Related Art

X-rays are used as a probe for looking through the inside of a subject as they attenuate, when passing through a substance, according to the atomic number of the element constituting the substance, as well as the density and thickness of the substance. X-ray imaging is widely used in the fields of medical diagnosis, nondestructive inspection, and the like.

In a general X-ray imaging system, a transmission image of a subject is captured by placing the subject between an X-ray source that emits X-rays and an X-ray image detector that detects X-ray images. In this case, each X-ray emitted from the X-ray source toward the X-ray image detector is incident on the X-ray detector after being attenuated (absorbed) by an amount corresponding to a difference in properties (atomic number, density, thickness) of the substance constituting the subject located in the transmission path from the X-ray source to the X-ray image detector. As a result, an X-ray transmission image of the subject is detected by the X-ray image detector and a radiation image is produced. As for the X-ray image detector, flat panel detectors using a semiconductor circuit are widely used, in addition to combinations of X-ray intensifying screens with films and photostimulable phosphors.

However, the X-ray absorption power is low for a substance constituted by an element with a small atomic number in comparison with a substance constituted by an element with a high atomic number. As such, the difference in X-ray absorption power is small in soft biological tissues and soft materials, thereby causing a problem of insufficient contrast as an X-ray transmission image. For example, the articular cartilage and synovial fluid constituting a joint of a human body consist mostly of water and the difference in the amount of X-ray absorption between them is small, thereby resulting in a low image contrast.

Recently, research has been conducted on X-ray phase contrast imaging for obtaining a phase contrast image based on X-ray phase shift resulting from the difference in refractive index of subject instead of X-ray intensity change resulting from the difference in absorption coefficient of subject. The X-ray phase contrast imaging using the phase difference of the X-ray wave-front may obtain a high contrast image even for a weak absorption object having a low X-ray absorption capability.

The X-ray phase contrast imaging is a new imaging method that utilizes X-ray phase/refraction information, and is capable of imaging a soft tissue which is difficult to be imaged by the conventional imaging method based on X-ray absorption due to a small absorption difference that produces almost no image contrast.

Heretofore, such soft-tissue portions may have been imaged by MRI, but the MRI imaging has problems of a long imaging time of several tens of minutes, a low image resolution of about 1 mm, and a low cost-effectiveness that makes it difficult to perform MRI imaging at regular physical examinations such as health checkups.

X-ray phase contrast imaging may also have been possible by monochromatic X-rays with well-aligned phase generated from a large scale radiation facility (e.g., SPring-8, Hyogo, JAPAN) or the like, but such a radiation facility is too large to be available in a general hospital.

Further, the X-ray phase contrast imaging may image cartilages and soft-tissue portions which is difficult to be observed in X-ray absorption contrast images as described above. Thus, a wide variety of the diseases, which includes joint disease, such as knee osteoarthritis, rheumatoid arthritis, sports disorders, meniscus injuries, tendon injuries, and ligament injuries, and other abnormality such as a tumor for breast cancer and the like, may be diagnosed quickly and easily with the X-ray phase contrast images. As such, the X-ray phase contrast imaging is a method that may contribute to early diagnosis, early treatment, and reduction of medical spending in an aging society.

As the X-ray phase contrast imaging described above, for example, an X-ray phase contrast image capturing system is proposed in which first and second grids are disposed in parallel at a given distance to form a self-image of the first grid at the position of the second grid by the Talbot interference effect and an X-ray phase contrast image is obtained from a plurality of images generated by intensity-modulating the self-image by the second grid.

In the mean time, various types of radiation image capturing cassettes, constituted by a radiation image detector or the like accommodated in a housing, are proposed. The radiation image capturing cassettes are easy to handle as they are thin and of a portable size. A radiation image signal detected by a radiation image detector in a cassette is transmitted from the cassette via a wireless communication unit as a wireless communication signal, and the transmitted wireless communication signal is received by a console and displayed as a phase contrast image after being subjected to various types of signal processing. Thus, it would be advantageous to employ such a cassette in the X-ray phase contrast image capturing system described above.

In the above-described X-ray phase contrast image capturing system, however, it is necessary to capture a plurality of radiation images by translating a second grid with respect to a first grid. If a radiation image signal is transmitted as a wireless communication signal from the cassette to the console each time a radiation image is captured, a next image can not be captured until the wireless transmission is completed as the transmission speed of the wireless communication signal by the wireless communication unit is very slow in comparison with that of a cable communication. Therefore, it is necessary to extend the interval for capturing images. This requires a prolonged time to complete the capturing of a plurality of images. In practice as a medical imaging, displacement (body motion) of the subject is likely to occur during the imaging time. Therefore, when a plurality of image capturing operations is performed as X-ray phase contrast imaging, some subjects can not keep still for a prolonged time, and the motion of the subject results in an image blur. Such subject displacement between image capturing operations causes a problem of significant degradation in the contrast or resolution of a phase contrast image. This problem is significant for a system that uses wireless communication due to a slow transmission speed, but the same problem of body motion of a subject may occur in a system that uses cable communication because a certain imaging interval is required even for the cable communication.

Consequently, it may be considered to perform the transmission of wireless communication signal and the capturing of a next radiation image (recording and reading) in parallel in order to reduce the image capturing interval. The radiation image reading, as well as the wireless transmission, requires large power consumption. Thus, parallel processing of the radiation image reading and wireless transmission will result in a large power load and increased heat generation in a control circuit or the like of a flat panel detector (FPD) in the cassette, thereby posing a problem of an offset fluctuation due to a temperature variation and the like.

The FPD includes a photoelectric conversion element that directly or indirectly converts X-rays to electric charges in each pixel and a readout circuit that reads out an electric charge generated in each pixel, then converts the electric charge to digital image data, and outputs the image data. A signal value of each pixel constituting the image data includes an offset component due to pixel dark current or temperature drift of the readout circuit and an offset correction for removing the offset component is generally performed. In the radiation imaging system described in WO 2008-102654, an offset correction is also performed on image data, but not described in detail. In a typical offset correction process, correction data are obtained by reading each pixel of the FPD without projecting X-rays prior to performing an image capturing operation. The correction data reflect an offset due to pixel dark current or temperature drift of the readout circuit. The offset correction of image data captured by the image capturing operation is performed by subtracting the correction data from the captured image data.

The offset due to the pixel dark current or temperature drift of the readout circuit depends on the temperature of the pixel and readout circuit. In the X-ray phase contrast image capturing system described above, a fringe scanning method is used to generate a phase contrast image and a plurality of image capturing operations is performed by translating the second grid at a predetermined scanning pitch. Consequently, if a large amount of heat is generated in the control system circuit and the like, the temperature of the pixel and readout circuit is likely to rise, causing an offset fluctuation between image capturing operations.

The phase contrast image is generated based on an X-ray refraction angle distribution calculated from a variation of signal values of each pixel obtained by a plurality of image capturing operations. The refraction angle of an X-ray due to phase shift of the X-ray wave-front that may occur by interacting with a subject is several micro-radians at the highest for soft tissue. Consequently, an amount of positional displacement of X-ray which should be detected on the radiation image detector in order to obtain a sufficient image contrast to identify such a tissue is fractional of a several micrometers. In the X-ray phase contrast image capturing system described above, a plurality of image capturing operations is performed by translating the second grid at a predetermined scanning pitch as described above and a phase contrast image is reconstructed by measuring a positional displacement amount of an X-ray from a fractional intensity change of a plurality of moiré images with respect to each pixel obtained by the X-ray image detector. Consequently, an offset fluctuation between image capturing operations becomes a calculation error when calculating a refraction angle distribution. Then, the calculation error may cause granularity, degradation in contrast or resolution, thereby causing significant degradation in the diagnostic and inspection capability. In this way, the impact of offset fluctuation on the phase contrast image is far greater when compared to an ordinary X-ray still or motion image which is not an image reconstructed by calculation based on a fractional intensity change in a plurality of images.

The impact is also great when compared to CT (Computed Tomography), tomosynthesis, or the like that reconstructs an image after capturing a plurality of images of a subject by changing the incident angle of the X-ray on the subject. The reason is that in the X-ray phase contrast image capturing system described above, a plurality of image capturing operations is performed by translating the second grid without changing the incident angle of the X-ray on the subject and a phase contrast image is reconstructed by measuring a positional displacement amount of the X-ray, which is just several micrometers on the radiation image detector, from a fractional intensity change of a plurality of moiré images. Here, images themselves of the subject are almost not changed. On the other hand, in CT or tomosynthesis imaging in which images are captured by changing the incident angle of the X-ray, the images of the subject change greatly. In comparison with other radiation imaging in which a reconstruction image is calculated from a plurality of such images, the impact of a fractional image change on the phase contrast image is great. Also in energy subtraction imaging in which subject images are captured by X-rays having a plurality of different energies with the same incident angle and a distribution of the energy absorption is reconstructed to separate soft tissues from bone tissues, the contrast of the subject changes greatly among a plurality of images due to difference in the imaging energy. Thus, in comparison with the energy subtraction image, the impact of a fractional image change due to an offset fluctuation on the phase contrast image is great. Therefore, the phase contrast image has a problem that the impact of an offset fluctuation due to heat generation on the reconstructed image is significantly great.

In the X-ray phase contrast image capturing system described above, WO 2008-102654 proposes to associate a set of radiation images for reconstructing a phase contrast image with each other by attaching a common ID. But it describe neither any specific method for transmitting the wireless communication signal from the cassette to console nor the heat generation problem in the cassette when capturing a plurality of images.

In view of the circumstances described above, it is an object of the present invention to provide a radiation image obtaining method and radiation image capturing apparatus, in which a plurality of radiation images is captured by translating a second grid with respect to a first grid and the plurality of radiation images is transmitted, capable of reducing workload of a control circuit that performs radiation image capturing control and wireless communication signal output control and the like, thereby minimizing heat generation.

SUMMARY OF THE INVENTION

A radiation image capturing apparatus of the present invention is an apparatus which includes: a first grid provided with grid structures disposed at intervals and forms a first periodic pattern image by passing radiation emitted from a radiation source; a second grid that receives the first periodic pattern image and forms a second periodic pattern image; a radiation image detector that detects the second periodic pattern image formed by the second grid; and a scanning mechanism that moves at least one of the first and second grids in a direction orthogonal to an extension direction of the one of the grids, and which obtains radiation image signals representing a plurality of second periodic pattern images detected by the radiation image detector at each position of the one of the grids along with the movement by the scanning mechanism,

wherein the apparatus further comprises:

a storage unit for storing the plurality of radiation image signals;

an association unit for associating the plurality of radiation image signals stored in the storage unit; and

a communication unit for transmitting one set of the radiation image signals associated by the association unit at a time.

The radiation image capturing apparatus of the present invention described above may include a cassette in which the radiation image detector, the storage unit, and the communication unit are accommodated and the cassette may be configured to be removably attachable.

Further, the apparatus may include a partial radiation image signal obtaining unit that obtains a radiation image signal in a partial area of each radiation image signal stored in the storage unit, in which case the association unit may be a unit that associates each radiation image signal in the partial area, and the communication unit may be a unit that transmits one set of the associated radiation image signals in the partial area at a time.

Still further, the partial area described above may be a region of interest.

Further, the apparatus may include a compression processing unit that performs compression processing on the plurality of radiation image signals, in which case the association unit may be a unit that associates the compression processed radiation image signals and the communication unit may be a unit that transmits one set of the compression processed radiation image signals associated by the association unit at a time.

Still further, the apparatus may include a compression processing unit that performs compression processing on the plurality of radiation image signals in the partial area, in which case, the association unit may be a unit that associates the compression processed radiation image signals and the communication unit may be a unit that transmits one set of the compression processed radiation image signals associated by the association unit at a time.

Still further, the association unit may be a unit that performs association processing based on header information of each radiation image signal.

Further, the association unit may be a unit that performs the association processing based on patient information included in the header information of each radiation image signal.

Still further, the communication unit may be a unit that performs wireless communication.

A radiation image obtaining method of the present invention is a method which uses a radiation image capturing apparatus, including: a first grid which includes grid structures disposed at intervals and forms a first periodic pattern image by passing radiation emitted from a radiation source; a second grid that receives the first periodic pattern image and forms a second periodic pattern image; a radiation image detector that detects the second periodic pattern image formed by the second grid; and a scanning mechanism that moves at least one of the first and second grids in a direction orthogonal to an extension direction of the one of the grids, and which obtains radiation image signals representing a plurality of second periodic pattern images detected by the radiation image detector at each position of the one of the grids along with the movement by the scanning mechanism, the method comprising the steps of:

storing the plurality of radiation image signals and associating the plurality of stored radiation images; and

transmitting one set of the associated radiation image signals at a time.

According to the radiation image obtaining method and radiation image capturing apparatus of the present invention, a plurality of image signals detected by the radiation image detector at each position of either one of the grids is stored and the plurality of stored radiation images are associated, and one set of the associated radiation image signals are transmitted at a time. This does not require simultaneous parallel processing of the transmission of an already captured radiation image signal and the capturing of a next radiation image signal and may reduce the workload of the control circuit that performs radiation image capturing control or communication signal output control, or the like, whereby heat generation and hence offset fluctuation may be minimized.

In the radiation image capturing apparatus described above, in the case where a radiation image signal in a partial area of each radiation, image signal stored in the storage unit is obtained, then each radiation image signal in the partial area is associated, and one set of the associated radiation image signals in the partial area are transmitted at a time, the amount of transmission data may be reduced, whereby transmission time may be reduced, and heat generation and hence offset fluctuation may further be reduced.

Further, in the case where the radiation images are compression processed and the compression processed radiation images are associated and transmitted at a time, the amount of transmission data may further be reduced, whereby transmission time and heat generation time may be reduced, resulting in further reduction in the amount of heat generation and offset fluctuation.

Further, in the case where association processing is performed based on header information of each radiation image signal, the association processing may be performed based on header information, such as patient information or the like, so that it is not necessary to newly set an ID or the like and association processing may be performed simply.

### BRIEF DESCRIPTION OF THE DRAWINGS

FIG. 1 is a schematic configuration diagram of a breast image capturing and display system using an embodiment of the radiation image capturing apparatus of the present invention.

FIG. 2 is a schematic view illustrating the radiation source, first and second grids, and radiation image detector of the breast image capturing and display system shown in FIG. 1.

FIG. 3 is a top view of the radiation source, first and second grids, and radiation image detector shown in FIG. 2.

FIG. 4 is a schematic configuration diagram of the first grid.

FIG. 5 is a schematic configuration diagram of the second grid.

FIG. 6 is a block diagram of the cassette unit, illustrating an internal configuration thereof.

FIG. 7 is a block diagram of the computer of the breast image capturing and display system shown in FIG. 1, illustrating the internal configuration thereof.

FIG. 8 is a flowchart illustrating an operation of the breast image capturing and display system using an embodiment of the radiation image capturing apparatus of the present invention.

FIG. 9 illustrates, byway of example, a path of one radiation ray refracted according to a phase shift distribution Φ(x) in X direction of a subject.

FIG. 10 illustrates translation of the second grid.

FIG. 11 illustrates a method of generating a phase contrast image.

FIG. 12 is a block diagram of a cassette unit of an alternative embodiment, illustrating an internal configuration thereof.

FIGS. 13A to 13C illustrate an example radiation image detector having the function of the second grid.

FIGS. 14A and 14B illustrate an operation for recording a radiation image in the radiation image detector shown in FIGS. 13A to 13C.

FIG. 15 illustrates an operation for reading out a radiation image from the radiation image detector shown in FIGS. 13A to 13C.

FIG. 16 illustrates another example radiation image detector having the function of the second grid.

FIGS. 17A and 17B illustrate an operation for recording a radiation image in the radiation image detector shown in FIG. 16

FIG. 18 illustrates an operation for reading out a radiation image from the radiation image detector shown in FIG. 16.

FIG. 19 illustrates an alternative shape of the charge storage layer of the radiation image detector shown in FIG. 16.

FIG. 20 illustrates how to generate an absorption image and a small angle X-ray scattering image.

FIG. 21 illustrates a configuration for rotating the first and second grids by 90°.

### DESCRIPTION OF THE PREFERRED EMBODIMENTS

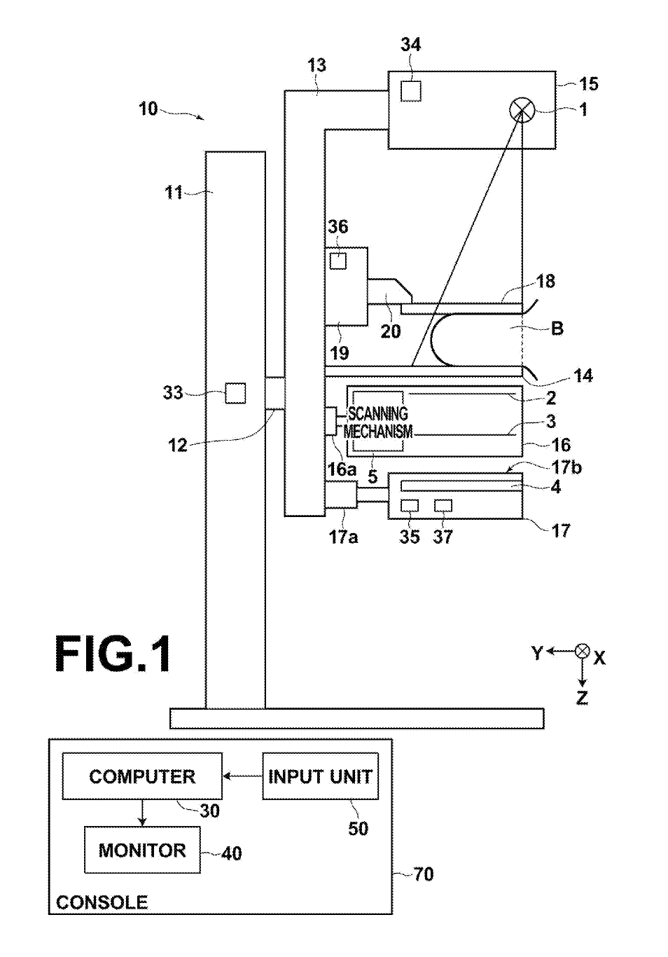

Hereinafter, a breast image capturing and display system using an embodiment of the radiation image capturing apparatus of the present invention will be described with reference to the accompanying drawings. FIG. 1 is a schematic configuration diagram of a breast image capturing and display system using an embodiment of the radiation image capturing apparatus of the present invention, illustrating an overview thereof.

As shown in FIG. 1, the breast image capturing and display system includes breast image capturing apparatus 10 and console 70 having computer 30, monitor 40, and input unit 50. Breast image capturing apparatus 10 includes base 11, rotary shaft 12 which is movable in up and down directions with respect to base 11 (Z directions), as well as being rotatable, and arm 13 coupled to base 11 via rotary shaft 12.

Arm 13 has a shape of an alphabet C, and imaging platform 14 for placing breast B is provided on one side thereof and radiation source unit 15 is provided on the other side so as to face the imaging platform 14. The movement of arm 13 in up and down directions is controlled by arm controller 33 built in based 11.

Further, grid unit 16 and cassette unit 17 are arranged on the opposite side of the breast placement surface of imaging platform 14 in this order.

Grid unit 16 is coupled to arm 13 via grid support 16a and includes therein first grid 2, second grid 3, and scanning mechanism 5, to be described later in detail.

Cassette unit 17 is coupled to arm 13 via cassette support 17a that supports cassette unit 17 and allows cassette unit 17 to be removably attached.

In the present embodiment, cassette unit 17 is configured to be attachable to and removable from cassette support 17a, thereby being made to be removably attachable. But, for example, cassette unit 17 may be configured to be fixedly attached to arm 13, as in grid unit 16, and withdrawable from the optical path of the radiation in order to be moved into and out of the optical path of the radiation, whereby cassette unit 17 may be made to be removably attachable.

In the present embodiment, it is assumed that a plurality of types of cassette units 17 of different sizes is configured to be removably attachable.

Cassette unit 17 has housing 17b made of a material that transmits radiation in which radiation image detector 4, such as a flat panel detector or the like, cassette controller 35, and wireless communication unit 37 are accommodated. The internal configuration of cassette unit 17 will be described later in detail.

Radiation source unit 15 includes therein radiation source 1 and radiation source controller 34. Radiation source controller 34 controls the timing of radiation emission from radiation source 1 and radiation generation conditions (tube current, time, tube voltage, and the like) for radiation source 1.

Further, compression plate 18 disposed above imaging platform 14 to hold and compress a breast, compression plate support 20 for supporting compression plate 18, and compression plate moving mechanism 19 for moving compression support 20 in up and down directions (Z directions) are provided at arm 13. The position of compression plate 18 and compression pressure are controlled by compression plate controller 36.

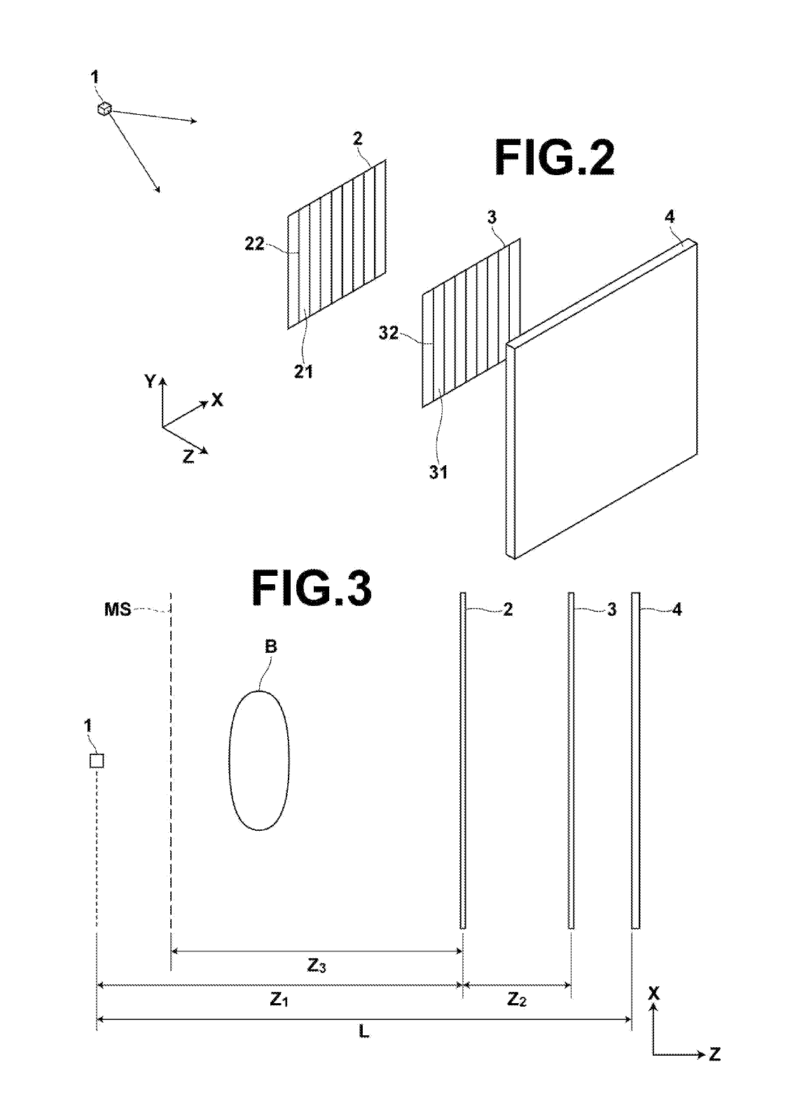

The breast image capturing and display system of the present embodiment is a system for capturing a phase contrast image of a breast B using first grid 2, second grid 3, and radiation image detector 4. Now, a configuration of radiation source 1, first grid 2, and second grid 3 required for capturing the phase contrast image will be described in detail. FIG. 2 illustrates only radiation source 1, first grid 2, second grid 3, and radiation image detector 4 extracted from FIG. 1. FIG. 3 schematically illustrates radiation source 1, first grid 2, second grid 3, and radiation image detector 4 shown in FIG. 2 viewed from above.

Radiation source 1 emits radiation toward the breast B and has enough spatial coherence to cause Talbot interference effect when radiation is incident on first grid 2. For example, a micro focus X-ray tube having a small radiation emission point or a plasma X-ray source may be used for this purpose. In the case where a radiation source having a relatively large radiation emission point (so-called focus spot size), like that used in general medical practice, is used, a multi-slit having a given pitch may be disposed on the emission side of the radiation. The detailed configuration in this case is described, for example, in “Phase retrieval and differential phase-contrast imaging with low-brilliance X-ray sources” by Franz Pfeiffer, Timm Weikamp, Oliver Bunk, and Christian David, Nature Physics 2, Letters, 258-261 (1 Apr. 2006), and pitch P0 of the slit should satisfy Formula (1) given below.

P₀=P₂×Z₃/Z₂ (1)

where, P₂ is a pitch of second grid 3, Z₃ is a distance from the position of the multi-slit MS to first grid 2, as shown in FIG. 3, and Z₂ is a distance from first grid 2 to second grid 3.

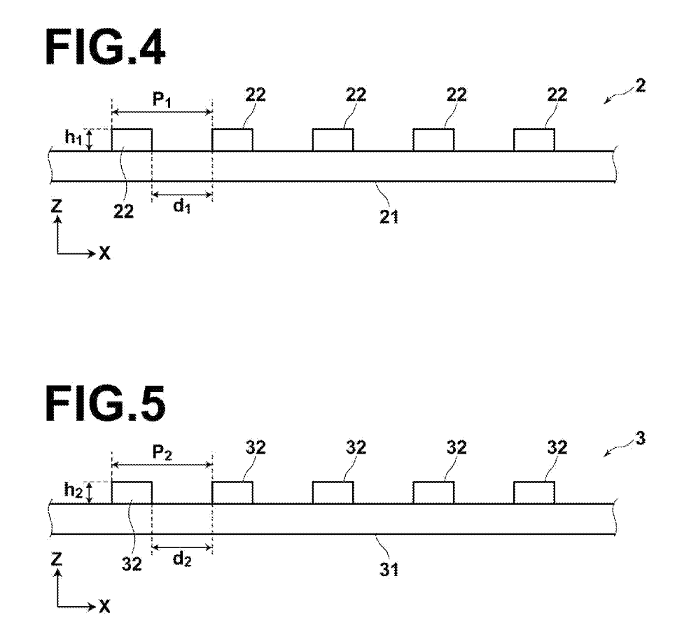

First grid 2 transmits radiation emitted from radiation source 1 to form a first periodic pattern image. The grid includes substrate 21 that primarily transmits radiation and a plurality of members 22 provided on substrate 21, as shown in FIG. 4. Each of the plurality of members 22 is a linear member extending in one in-plane direction (Y direction orthogonal to X and Z directions, i.e., thickness direction of FIG. 4) orthogonal to the optical axis of radiation. The plurality of members 22 is disposed in X direction at constant pitch P₁ with a predetermined distance d₁ between each member. As for the material of members 22, for example, a metal such as gold or platinum may be used. Preferably, first grid 2 is a so-called phase modulation grid that produces a phase modulation of about 90° or about 180° in the projected radiation. Assuming, for example, that member 22 is made of gold, the thickness h₁ of each member in the energy range of X ray used for general medical diagnosis is one micrometer to ten micrometers. Further, an amplitude modulation grid may also be used. In this case, each member 22 needs to have a thickness that allows sufficient absorption of radiation. Assuming, for example, that member 22 is made of gold, the thickness h₁ of the member in the energy range of X ray used for general medical diagnosis is ten to several hundreds micrometers.

Second grid 3 intensity modulates the first periodic pattern image formed by first grid 2 to form a second periodic pattern image. As illustrated in FIG. 5, second grid 3 includes substrate 31 that primarily transmits radiation and a plurality of members 32 provided on substrate 31, as in first grid 2. The plurality of members 32 blocks radiation and each of them is a linear member extending in one in-plane direction (Y direction orthogonal to X and Z directions, i.e., thickness direction of FIG. 5) orthogonal to the optical axis of radiation. The plurality of members 32 is disposed in X direction at constant pitch P₂ with a predetermined distance d₂ between each member. As for the material of members 22, for example, a metal such as gold or platinum may be used. Preferably, second grid 3 is an amplitude modulation grid. Each member 32 needs to have a thickness that allows sufficient absorption of radiation. Assuming, for example, that member 32 is made of gold, the thickness h₂ of the member in the energy range of X ray used for general medical diagnosis is ten to several hundreds micrometers.

Here, in the case where radiation emitted from radiation source 1 is a cone beam instead of a parallel beam, a self image G1 of first grid 2 formed by radiation transmitted through first grid 2 is enlarged in proportion to the distance from radiation source 1. In the present embodiment, the grid pitch P₂ and distance d₂ of second grid 3 are determined such that the slit section thereof substantially corresponds to the periodic pattern of the bright portions of the self image G1 of first grid 2 at the position of second grid 3. That is, if the distance from the focal point of radiation source 1 to first grid 2 is taken as Z₁, and the distance from first grid 2 to second grid 3 is taken as Z₂, in the case where the first grid 2 is a phase modulation grid that applies phase modulation of 90° or an amplitude modulation grid, pitch P₂ of second grid 3 is determined so as to satisfy Formulae (2) given below.

$${P}_{2} = {P}_{1}^{′} = \frac{{Z}_{1} + {Z}_{2}}{{Z}_{1}} {P}_{1} \qquad ( 2 )$$

where P₁′ is a pitch of the self image G1 formed by the first grid 2 at the position of the second grid 3. Alternatively, in the case of the first grid 2 is a phase modulation grid that applies phase modulation of 180°, the pitch P₂ of the second grid is determined to satisfy the relationship defined as the Expressions (3) below:

$${P}_{2} = {P}_{1}^{′} = \frac{{Z}_{1} + {Z}_{2}}{{Z}_{1}} \cdot \frac{{P}_{1}}{2} \qquad ( 3 )$$

In the case where radiation emitted from radiation source 1 is a parallel beam, then pitch P₂ of second grid 3 is determined so as to satisfy P₂=P₁, where the first grid 2 is a 90° phase modulation grid or an amplitude modulation grid, or P₂=P₁/2, where the first grid 2 is an 180° phase modulation grid.

In order for breast image capturing apparatus 10 to function as a Talbot interferometer, some other conditions may also be substantially satisfied, which will be described hereinafter.

First of all, the grid surfaces of first grid 2 and second grid 3 should be parallel to the X-Y plane shown in FIG. 2.

In the case where first grid 2 is a phase modulation grid that produces a phase modulation of 90°, the following condition should be substantially satisfied.

$${Z}_{2} = ( m + \frac{1}{2} ) \frac{{P}_{1} {P}_{2}}{λ} \qquad ( 4 )$$

where, λ is a wavelength of the radiation (normally, effective wavelength), m is 0 or a positive integer, P₁ is a grid pitch of first grid 2 described above, and P₂ is a grid pitch of second grid 3 described above.

In the case where first grid 2 is a phase modulation grid that produces phase modulation of 180°, the following condition should be substantially satisfied.

$${Z}_{2} = ( m + \frac{1}{2} ) \frac{{P}_{1} {P}_{2}}{2 λ} \qquad ( 5 )$$

where, λ is a wavelength of the radiation (normally, effective wavelength), m is 0 or a positive integer, P₁ is a grid pitch of first grid 2 described above, and P₂ is a grid pitch of second grid 3 described above.

In the case where first grid 2 is an amplitude modulation grid, the following condition should be substantially satisfied.

$${Z}_{2} = {m}^{′} \frac{{P}_{1} {P}_{2}}{λ} \qquad ( 6 )$$

where, λ is a wavelength of the radiation (normally, effective wavelength), m′ is a positive integer, P₁ is a grid pitch of first grid 2 described above, and P₂ is a grid pitch of second grid 3 described above.

Formulae (4), (5), and (6) are applied to the case where radiation emitted from radiation source 1 is a cone beam, and if the radiation is a parallel beam, Formulae (7), (8), and (9) are applied instead of Formulae (4), (5), and (6) respectively.

$$\begin{matrix}{Z}_{2} = ( m + \frac{1}{2} ) \frac{{P}_{1}^{2}}{λ} & ( 7 ) \\ {Z}_{2} = ( m + \frac{1}{2} ) \frac{{P}_{1}^{2}}{4 λ} & ( 8 ) \\ {Z}_{2} = m \frac{{P}_{1}^{2}}{λ} & ( 9 )\end{matrix}$$

Further, as illustrated in FIGS. 4 and 5, members 22 of first grid are formed with a thickness of h₁ and members 32 of second grid are formed with a thickness of h₂, and overly thick members 22 and 32 cause radiation rays obliquely incident on first grid 2 and second grid 3 to become difficult to pass through the slit sections, i.e., cause a so-called vignetting phenomenon, posing a problem that the effective field of view in the direction orthogonal to the direction in which members 22 and 32 are extended (X direction) is reduced. Consequently, it is preferred to define upper limits for thicknesses h₁ and h₂ from the viewpoint of ensuring a satisfactory field of view. In order to ensure effective field of view V in the X direction on the detection surface of radiation image detector 4, thicknesses h₁ and h₂ should be set to values that satisfy Formulae (10) and (11) respectively, in which L is a distance from the focal point of radiation source 1 to the detection surface of radiation image detector 4 (FIG. 3).

$$\begin{matrix}{h}_{1} \leq \frac{L}{\frac{V}{2}} {d}_{1} & ( 10 ) \\ {h}_{2} \leq \frac{L}{\frac{V}{2}} {d}_{2} & ( 11 )\end{matrix}$$

Scanning mechanism 5 provided in grid unit 16 changes the relative position between first grid 2 and second grid 3 by translating second grid 3 in the direction orthogonal to the direction in which members 32 thereof are extended (X direction). Scanning mechanism 5 is formed of an actuator, such as a piezoelectric device. Then, at each position of second grid 3 translated by scanning mechanism 5, a second periodic pattern image formed by second grid 3 is detected by radiation image detector 4.

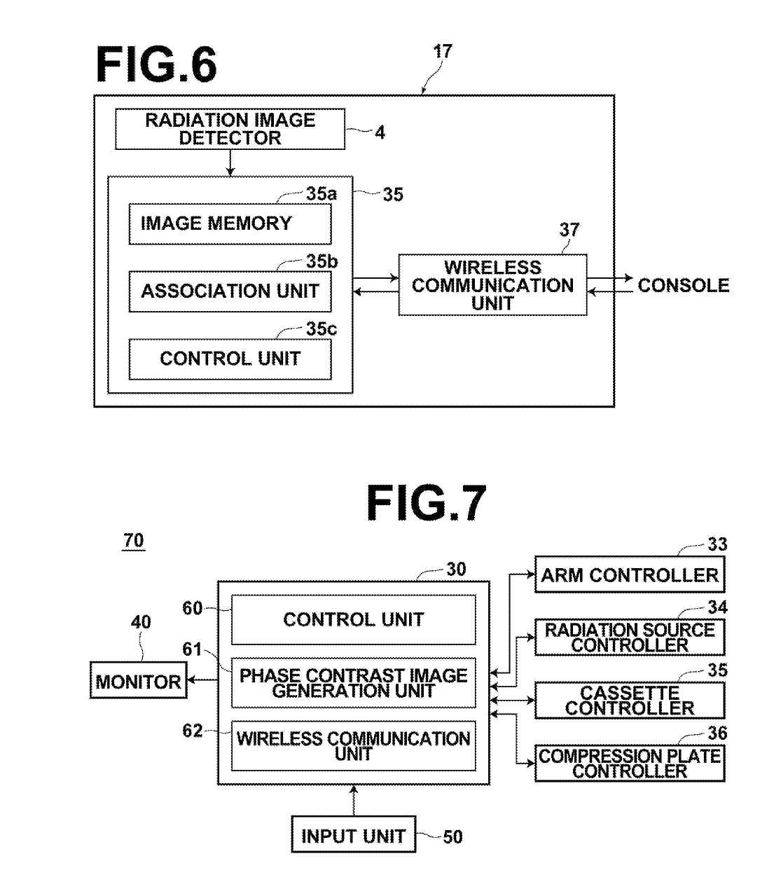

FIG. 6 is a block diagram of cassette unit 17, illustrating an internal configuration thereof. As described above, cassette unit 17 includes radiation image detector 4, cassette controller 35 that controls radiation image signal reading from radiation image detector 4 and stores the image signal read out from the detector, and wireless communication unit 37 that transmits the radiation image signal stored in cassette controller 35 or the like as a wireless communication signal and receives a control signal for controlling the wireless communication signal outputted from console 70.

Radiation image detector 4 includes pixels disposed two dimensionally to allow repetitions of recording and reading of radiation images. As for radiation image detector 4, a so-called direct type radiation image detector that directly receives radiation to generate electric charges or a so-called indirect type radiation image detector that receives visible light converted from radiation to generate electric charges maybe used. As for the readout method, a so-called TFT (thin film transistor) readout method in which radiation image signals are read by switching ON/OFF the TFT switches or an optical readout method in which a radiation image signal is read out by directing readout light to the detector is preferably used, but other methods may also be used.

As shown in FIG. 6, cassette controller 35 includes image memory 35a for storing a plurality of radiation image signals detected by radiation image detector 4 at each position of second grid 3, association unit 35b for associating the plurality of radiation image signals stored in image memory 35a, and control unit 35c for performing overall control of cassette unit 17, including control of charge signal reading from radiation image detector 4, control of radiation image signal reading from image memory 35c, and the like.

Association unit 35b associates a plurality of radiation image signals captured for reconstructing one phase contrast image as a set of radiation image signals. The term “associate” as used herein refers to causing the plurality of radiation image signals to have relation to each other. In the present embodiment, a plurality of radiation images is associated based on patient information of an imaging target subject, but the parameter for the association is not limited to the patient information, and any information may be used as long as it is related to a plurality of radiation image signals in common. For example, the association may be made using imaging menu, imaging region, the time of imaging, or the like. The imaging menu as used in the present embodiment refers to necessary conditions for performing radiation imaging, including imaging techniques and conditions for exposing the patient to appropriate dose of radiation, such as the tube voltage, tube current, exposure time, and the like. But, the imaging menu is not limited to those described above and any information may be included in the menu as long as it is a condition required for performing radiation imaging.

It is assumed that patient information, imaging menu, or information of imaging region or the like inputted by the radiological technologist via input unit 50 of console 70 is used, while time information of imaging measured by console 70 is used in the present embodiment. The patient information or the like obtained at console 70 is outputted toward cassette unit 17 as a wireless communication signal and received by wireless communication unit 37 of cassette 17. The patient information or the like received by cassette unit 17 is attached to a plurality of radiation image signals captured in relation to the patient information as header information when the plurality of radiation image signals is stored in image memory 35a.

Association unit 35b associates the plurality of radiation image signals as a set of radiation image signals for management via the header information. The association parameter is not limited to one type of information and a combination of two or more types of information may be used as the association parameter.

After a plurality of radiation image signals for reconstructing one phase contrast image is captured, control unit 35c reads out a set of radiation image signals associated with each other by association unit 35b from image memory 35a and transmits the set to console 70 at a time via wireless communication unit 37.

Although omitted in the drawing, cassette controller 35 includes therein a charge amplifier for converting charge signals read out from radiation image detector 4 to voltage signals, a correlated double sampling circuit for sampling the voltage signals outputted from the charge amplifier, an A/D converter for converting the voltage signals to digital signals, and the like.

FIG. 7 is a block diagram of computer 30 of console 70 shown in FIG. 1, illustrating the configuration thereof. Computer 30 includes a central processing unit (CPU) and a storage device, such as a semiconductor memory, hard disk, or SSD, and such hardware forms control unit 60, phase contrast image generation unit 61, and wireless communication unit 62.

Control unit 60 performs overall control of the system by outputting predetermined control signals to various types of controllers 33 to 36 as wireless communication signals via wireless communication unit 62. It is assumed that each of Arm controller 33, radiation source controller 34, and compression plate controller 36 provided with a receiving unit capable of receiving a wireless communication signal transmitted from wireless communication unit 62 of computer 30.

Further, control unit 60 also transmits patient information, imaging menu, or information of imaging region or the like received via input unit 50 to cassette controller 35 of cassette unit 17 via wireless communication unit 62.

Phase contrast image generation unit 61 may generate a phase contrast image based on a plurality of radiation image signals detected by radiation image detector 4 at each position of second grid 3. The method of generating the phase contrast image will be described in detail later.

Wireless communication unit 62 transmits control signals to various controllers 33 to 36 as wireless communication signals, as described above, as well as receiving a set of radiation image signals transmitted from wireless communication unit 37 of cassette unit 17 and outputting the received signals to phase contrast image generation unit 61.

In the present embodiment, a set of radiation image signals and imaging menu are exchanged between wireless communication unit 37 of cassette unit 17 and wireless communication unit 62 of computer 30 in console 70 through wireless communication. But the wireless communication is not necessarily used and such information may be exchanged via cable communication over a cable connecting cassette unit 17 and computer 30, or the like. Further, in the present embodiment, cassette unit 17 having radiation image detector 4 is configured to be removably attachable to the body of breast image capturing apparatus 10, but the elements in cassette unit 17 may be integrated in the body of breast image capturing apparatus 10.

Monitor 40 may display the phase contrast image generated by phase contrast image generation unit 61 of computer 30.

Input unit 50 includes, for example, a pointing device, such as a keyboard or a mouse, to receive input from the radiological technologist, such as patient information, imaging menu, information of imaging region, an instruction to start imaging, and the like.

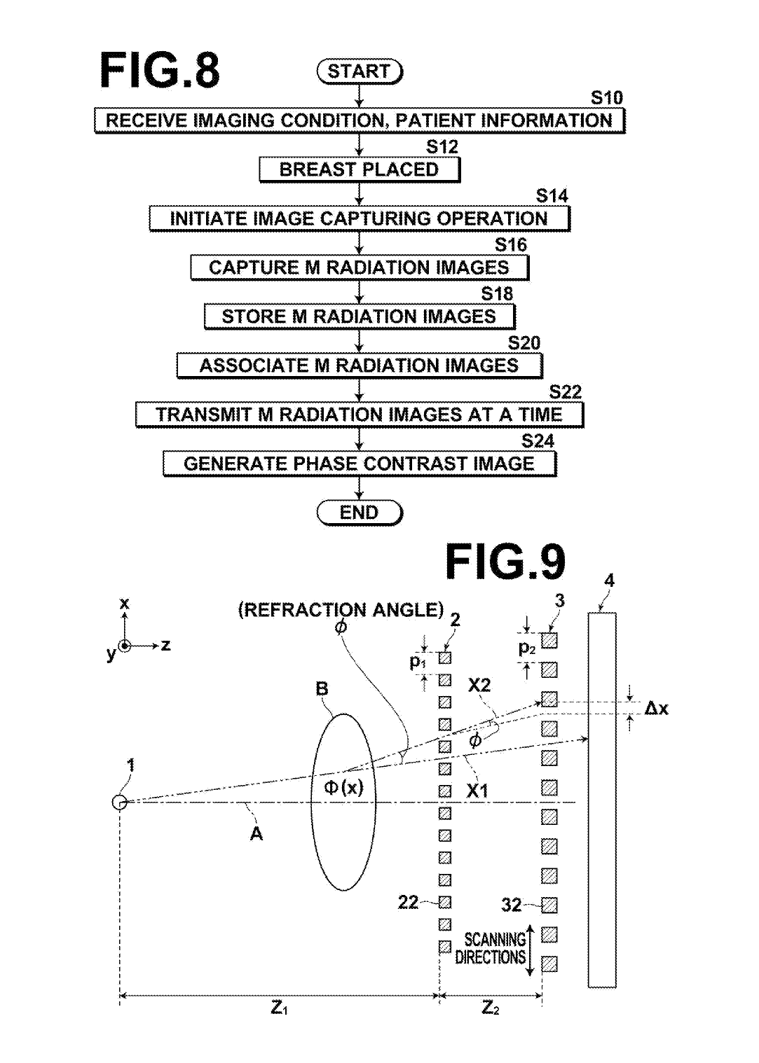

An operation of the breast image capturing and display system of the present embodiment will now be described with reference to the flowchart shown in FIG. 8.

First, a desired cassette unit 17 is selected by the radiological technologist from various types of cassette units 17 of different sizes according to the size of the breast B and imaging techniques, and selected cassette unit 17 is attached to cassette support 17a.

The patient information, imaging menu, or information of imaging region is entered by the radiological technologist via input unit of console 70 (S10).

Then a breast B of a patient is placed on the imaging platform 14 and the breast B is compressed by compression plate 18 at a predetermined pressure (S12).

Next, an image capturing operation start instruction for a phase contrast image is entered by the radiological technologist via input unit 50 (S14) and a control signal is outputted from control unit 60 of computer 30 in response to the entry of image capturing operation start instruction. The control signal is transmitted to radiation source controller 34 and cassette controller 35 via wireless communication unit 62, whereby a phase contrast image capturing operation is initiated (S16). Here, the patient information, imaging menu, or information of imaging region entered via input unit 50 is also transmitted toward cassette controller 35 of cassette unit 17 via wireless communication unit 62.

Then, radiation is emitted from radiation source 1 according to the control signal transmitted from console 70 and the radiation transmits through the breast B and incident on first grid 2. The radiation incident on first grid 2 is diffracted by first grid 2 and a Talbot interference image is formed at a given distance from first grid 2 in the optical axis direction of the radiation.

This phenomenon is known as the Talbot effect, and a self image G1 of first grid 2 is formed at a given distance from first grid 2 when a radiation wave-front passes through first grid 2. For example, in the case where first grid 2 is a phase modulation grid that produces a phase modulation of 90°, a self image G1 is formed at a distance given by Formula (4) or Formula (7) above (where first grid 2 is a phase modulation grid that produces a phase modulation of 180°, Formula (5) or Formula (8), and where first grid 2 is an intensity modulation grid, Formula (6) or Formula (9)), in which the wave-front incident on first grid 2 is distorted by the subject, i.e., breast B, and therefore the self image G1 of first grid 2 is deformed accordingly.

Thereafter, the radiation passes through second grid 3. As a result, the deformed self image G1 of first grid 2 is subjected to intensity modulation due to superimposition with second grid 3 and detected by radiation image detector 4 as an image signal reflecting the wave-front distortion described above. The radiation image signal detected by radiation image detector 4 is outputted to cassette controller 35 and stored in image memory 35a of cassette controller 35.

Next, a method of generating a phase contrast image in phase contrast image generation unit 61 will be described. But, to begin with, the principle of the phase contrast image generation method in the present embodiment will be described.

FIG. 9 illustrates a path of one radiation ray refracted according to a phase shift distribution Φ(x) with respect to X direction of the subject B. The reference symbol X1 denotes a straight path of the radiation ray in the absence of the subject B, and the radiation ray propagating through path X1 is incident on radiation image detector 4 after transmitting through first grid 2 and second grid 3. Reference symbol X2 denotes, in the case where the subject B is present, a path of deflected radiation ray due to refraction by the subject B. The radiation ray propagating through path X2 is blocked by second grid 3 after passing through first grid 2.

The phase shift distribution Φ(x) of the subject B is expressed by Formula (12) given below taking n (x, z) as the refractive index distribution of the subject B and z as the direction in which the radiation propagates. Here, y coordinate is omitted for the sake of convenience of explanation.

$$Φ ( x ) = \frac{2 π}{λ} {\int }_{ }^{ } [ 1 - n ( x , z ) ] d z \qquad ( 12 )$$

Self image G1 of first grid 2 formed at the position of second grid 3 is displaced in X direction due to refraction of the radiation ray at the subject B in an amount according to the refraction angle φ. The amount of displacement Δx may be approximated by Formula 13 given below based on the fact that the refraction angle φ is very small.

Δx≈Z₂φ (13)

where, the refraction angle φ may be expressed by Formula (14) given below using wavelength λ of the radiation ray and phase shift distribution Φ(x) of the subject B.

$$ϕ = \frac{λ}{2 π} \frac{\partial Φ ( x )}{\partial x} \qquad ( 14 )$$

As described above, the amount of displacement Δx of the self image G1 due to refraction of the radiation ray at the subject B is linked to the phase shift distribution Φ(x). Then, the amount of displacement Δx is linked to the phase shift amount Ψ of intensity modulated signal of each pixel (phase shift amount in intensity modulated signal of each pixel between the presence and absence of the subject B) detected by radiation image detector 4 in the manner represented by Formula (15) given below.

$$ψ = \frac{2 π}{{P}_{2}} Δ x = \frac{2 π}{{P}_{2}} {Z}_{2} ϕ \qquad ( 15 )$$

Accordingly, by obtaining the phase shift amount Ψ in the intensity modulated signal of each pixel, the refraction angle φ may be obtained by Formula (15), and a differential amount of the phase shift distribution Φ(x) may be obtained using Formula (14) given above. By integrating the differential amount with respect to x, the phase shift distribution Φ(x) of the subject B may be obtained, that is, the phase contrast image of the subject B may be generated. In the present embodiment, the phase shift amount Ψ is calculated by a fringe scanning method described below.

In the fringe scanning method, an image capturing operation described above is performed by translating either one of first grid 2 and second grid 3 relative to the other in X direction. In the present embodiment, second grid 3 is moved by scanning mechanism 5 described above. As second grid 3 is moved, the fringe image detected by radiation image detector 4 is moved and when a translation distance (movement amount in X direction) reaches one arrangement period of second grid 3 (arrangement pitch P₂), that is, when the phase variation between self image G1 of first grid 2 and second grid 3 reaches 2π, the fringe image returns to the original position. A fringe image is detected by radiation image detector 4 each time second grid 3 is moved by an amount of arrangement pitch P₂ divided by an integer, and intensity modulated signals of each pixel are obtained from a plurality of detected fringe images to obtain an phase shift amount Ψ in the intensity modulated signals of each pixel.

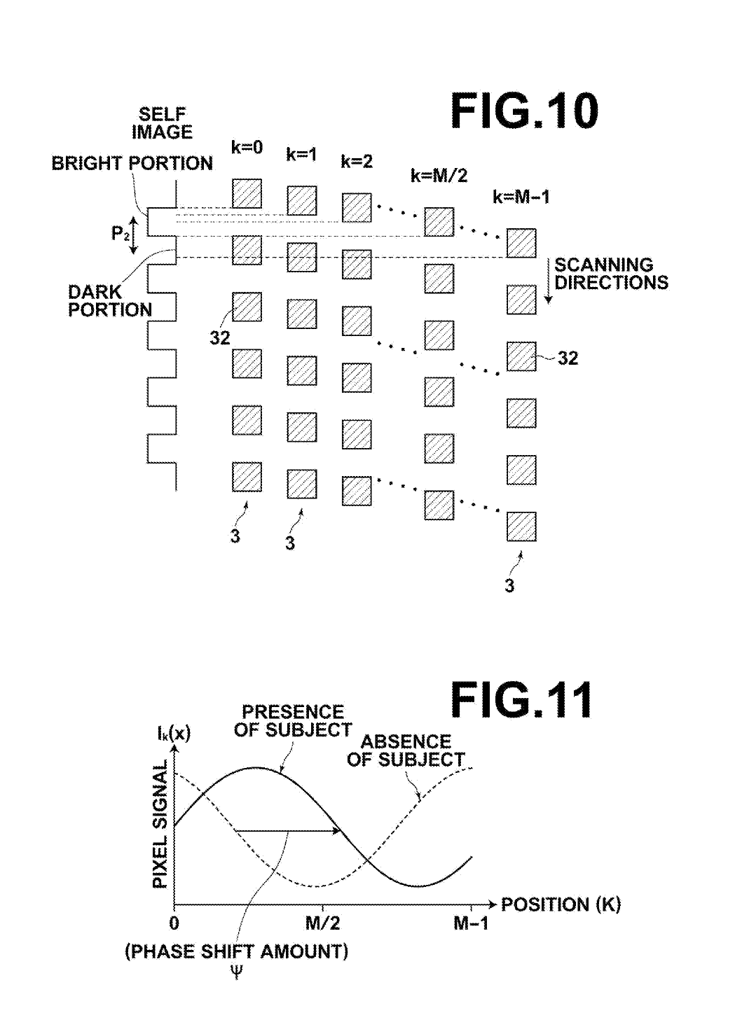

FIG. 10 schematically illustrates the movement of second grid 3 in increments of P₂/M, in which P₂ is the arrangement pitch of second grid 3 and M is an integer of two or greater. Scanning mechanism 5 sequentially translates second grid 3 to each of M positions of k=0, 1, 2, - - - , and M−1 to which second grid 3 is to be moved. Although FIG. 10 indicates that the initial position of second grid 3 is at a position where dark portions of self image G1 of first grid 2 at second grid 3 substantially correspond to members 32 of second grid 3 (k=0), the initial position may be any of the positions k−=0, 1, 2, - - - , and M−1.

At the position of K=0, the component of radiation not refracted by the subject B is mainly passed through second grid 3. Then, as second grid 3 is sequentially moved to positions k=0, 1, - - - , the radiation component not refracted by the subject B is decreased while the radiation component refracted by the subject is increased in the radiation passing through the second grid 3. In particular, at the position k=M/2, the radiation component refracted by the subject B is mainly passed through second grid 3. Then, after the position k=M/2, the radiation component refracted by the subject B is decreased while the radiation component not refracted by the subject is increased.

At each of the positions k=1, 2, - - - , and M−1, an image capturing operation is performed using radiation image detector 4 to obtain image signals of M fringe images and the fringe image signals are stored in image memory 35a of cassette controller 35 (S18).

When radiation image signals of M fringe images are stored in image memory 35a in the manner described above, the patient information, imaging menu, or information of imaging region is attached to each radiation image signal as header information. Further, each of the radiation image signals is associated with each other by association unit 35b based on the patient information in the header and managed (S20).

After radiation image signals of M fringe images constituting one phase contrast image are associated and stored, control unit 35c of cassette unit 17 reads out the one set of associated and managed radiation image signals from image memory 35a and cases wireless communication unit 37 to transmit the one set of radiation image signals toward console 70 at a time (S22).

The radiation image signals of M fringe images transmitted from wireless communication unit 37 of cassette 17 at a time are received by wireless communication unit 62 of console 70 and inputted to phase contrast image generation unit 61.

Then, a phase contrast image is generated in phase contrast image generation unit 61 based on the radiation image signals of M fringe images.

A method of calculating a phase shift amount W of intensity modulated signal of each pixel from pixel signals of each pixel of the image signals of M fringe images will now be described.

First, the pixel signal Ik(x) of each pixel at the position k of second grid 3 may be represented by Formula (16) given below.

$${I}_{k} ( x ) = {A}_{0} + {\sum }_{n > 0}^{ } {A}_{n} exp [ 2 π i \frac{n}{{P}_{2}} \{ {Z}_{2} ϕ ( x ) + \frac{{kP}_{2}}{M} \} ] \qquad ( 16 )$$

where, x is the coordinate of the pixel in x direction, A₀ is the intensity of incident radiation, and A₀ is the value corresponding to the contrast of the intensity modulated signal (n is a positive integer, here). The φ(x) is the representation of the refraction angle φ as a function of the coordinate x of the pixel of radiation image detector 4.

Then, the use of the relationship represented by Formula (17) given below may result in that the refraction angle φ(x) is expressed as Formula (18) given below.

$$\begin{matrix}{\sum }_{k = 0}^{M - 1} exp ( - 2 πi \frac{k}{M} ) = 0 & ( 17 ) \\ ϕ ( x ) = \frac{{p}_{2}}{2 π {Z}_{2}} arg [ {\sum }_{k = 0}^{M - 1} {I}_{k} ( x ) exp ( - 2 πi \frac{k}{M} ) ] & ( 18 )\end{matrix}$$

where, arg [ ] implies extraction of an argument corresponding to the phase shift amount Ψ of each pixel of radiation image detector 4. Therefore, the refraction angle φ(x) may be obtained by calculating the phase shift amount Ψ of intensity modulated signal of each pixel from M fringe image signals obtained for each pixel based on Formula (18).

More specifically, as illustrated in FIG. 11, the M fringe image signals obtained from each pixel of radiation image detector 4 varies periodically with respect to the position k of second grid 3. The broken line in FIG. 11 indicates a fringe image signal variation in the absence of the subject B while the solid line indicates a fringe image signal variation in the presence of the subject B. The phase difference between the two waveforms corresponds to the phase shift amount Ψ of intensity modulated signal of each pixel.

As the refraction angle φ(x) is a value corresponding to a differential value of the phase shift distribution Φ(x) as indicated by Formula (14) above, the phase shift distribution Φ(x) may be obtained by integrating the refraction angle φ(x) along x axis.

In the description above, y coordinate of pixel in y direction is not considered, but an identical calculation may be made for each y coordinate, whereby a two-dimensional distribution of refraction angles φ(x, y) may be obtained. Then, by integrating the two-dimensional distribution of refraction angles φ(x, y) along the x axis, a two-dimensional phase shift distribution Φ(x, y) may be obtained as a phase contrast image.

Further, the phase contrast image may be generated by integrating the two-dimensional distribution of phase shift amounts Ψ(x, y) along x axis, instead of the two-dimensional distribution of refraction angles φ(x, y).

The two-dimensional distribution of refraction angles φ(x, y) or two-dimensional distribution of phase shift amounts Ψ(x, y) is known as a differential phase image as they correspond to differential values of phase shift distribution Φ(x, y), and the differential phase image may be generated as the phase contrast image.

As described above, a phase contrast image is generated in phase contrast image generation unit 61 based on M radiation image signals.

Then, the phase contrast image generated in phase contrast image generation unit 61 is outputted to monitor 40 and displayed thereon.

In the embodiment described above, each radiation image signal is outputted from cassette unit 17 to console 70 in whole. In order to reduce the transmission time, however, it is desirable to transmit only a radiation image signal in a partial area of each radiation image signal.

Hence, when, for example, reading out each radiation image signal from image memory 35a of control unit 35c, only a partial radiation image signal, which is a radiation image signal in a partial area of each radiation image signal, representing a region of interest may be extracted and a set of the extracted partial radiation image signals may be transmitted from wireless communication unit 37 toward console 70 at a time.

The region of interest may be set in advance or may be set arbitrarily by the radiological technologist using input unit 50.

Further, the relationship between the radiation image detection area of radiation image detector 4 in cassette unit 17 to be used and the radiation transmission area of first and second grids 2, 3 in grid unit 16 may be registered in advance and a region on the radiation image detection area of radiation image detector to be exposed by radiation transmitted through first and second grating 2, 3 may be set as a region of interest.

Further, a joint may be recognized through a gap between bones by a known image recognition method in control unit 35c and an image area of the joint including a surrounding area may be set as a region of interest. In that case, imaging region information may be obtained from the imaging menu or the like and the imaging region may be recognized by a known image recognition method through comparison with a data base image having a typical morphology of the imaging region and the recognized imaging region, such as a joint or breast, may be set as a region of interest. The captured image has a moiré pattern which is formed by self image G1 of first grid 2 and second grid 3, but a region of interest having a high contrast, such as a joint or breast, may well be recognized.

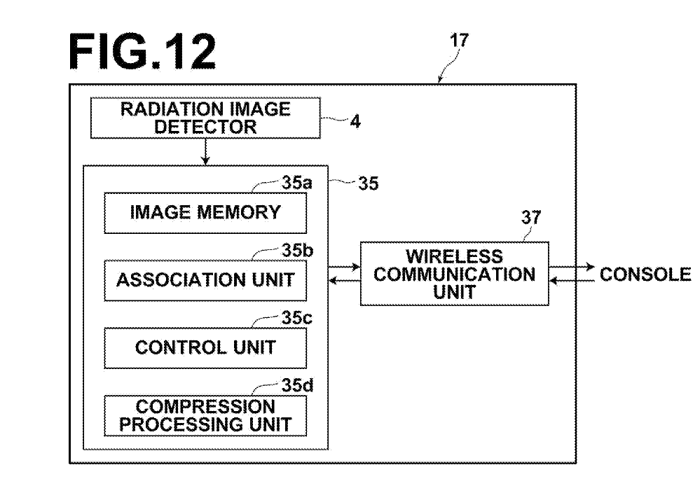

Still further, compression processing unit 35d for compressing each radiation image signal stored in image memory 35a by a known compression method may be provided, as illustrated in FIG. 12, in which case association unit 35b may be configured to associate each compressed radiation image signal and wireless communication unit 37 may be configured to transmit the associated one set of compressed radiation image signals at a time.

In the compression processing unit 35d, a difference between a reference image and the other image may be calculated and compression processing may be performed on the difference image. As for the reference image, for example, a first image of a plurality of images constituting a phase contrast image or an immediately preceding image may be used. In phase contrast imaging, in particular, image capturing is performed by translating second grating 3 and a fractional positional displacement of about 1 μm due to the phase shift of radiation is superimposed on a subject image as a moiré pattern, so that the subject image itself does not almost change between each of images, but each image is highly correlated. Consequently, when difference image is taken with respect to the reference image, the variation is small and has more low frequency components, whereby compression ratio may be increased significantly. Furthermore, image data may further be reduced by compressing a certain area of each image.

In the radiation image capturing system in the embodiment described above, cassette unit 17 is configured to be removably attachable, but cassette unit 17 may be fixed.

In the radiation image capturing apparatus of the embodiment described above, the distance Z₂ from the first grid 2 to second grid 3 is set to the Talbot interference distance, but a configuration may be adopted in which first grid 2 projects the incident radiation without diffraction. Such configuration will result in that a projection image projected through first grid 2 may be obtained analogously at any position behind first grid 2, so that the distance Z₂ from the first grid 2 to second grid 3 may be set independently of the Talbot interference distance.

More specifically, first grid 2 and second grid 3 are formed as absorption (amplitude modulation) grids and such that radiation passed through the slit sections thereof is projected geometrically, regardless of whether or not the Talbot effect is produced. More particularly, most of the incident radiation may be straightly passed through the slit sections without being diffracted by setting the distance d₁ between each member of first grid 2 and the distance d₂ between each member of second grid 3 to a value sufficiently larger than the effective wavelength of radiation emitted from radiation source 1. For example, in the case of the radiation source with a tungsten target, the effective wavelength of the radiation is about 0.4 Å at a tube voltage of 50 kV. In this case, if the distance d₁ between each member of first grid 2 and the distance d₂ between each member of second grid 3 are set to a value from 1 μn to 10 μm, most of the radiation is geometrically projected without being diffracted by the slit.

The relationship between grid pitch P₁ of first grid 2 and grid pitch P₂ of second grid 3 is identical to that of the first embodiment.

In the radiation phase contrast image capturing system configured in the manner as described above, the distance Z₂ between first grid 2 and second grid 3 may be set to a value smaller than the minimum Talbot interference distance calculated by Formula (6) given above when 1 is substituted to m′ (m′=1). That is, the distance Z₂ is set to a value that satisfies Formula (19) given below.

$${Z}_{2} < \frac{{P}_{1} {P}_{2}}{λ} \qquad ( 19 )$$

Preferably, member 22 of first grid 2 and member 32 of second grid 3 completely block (absorb) radiation in order to generate a high contrast periodic pattern image. But radiation transmitting therethrough without being absorbed may present in no small amount even if a material with high absorption property (gold, platinum, or the like) is used. Therefore, in order to improve radiation blocking capability, it is preferable that the thicknesses h₁, h₂ of members 22, 23 are made as thick as possible. Preferably, radiation blocking of members 22, 32 is not less than 90% of the incident radiation. For example, in the case where the tube voltage of radiation source 1 is 50 kV, it is preferable that the thicknesses h₁, h₂ are not less than 100 μm in terms of gold (Au).

As in the embodiment described above, however, the problem of so-called vignetting of radiation may exist, so that the thicknesses h₁, h₂ of members 22, 23 of first grid 2 and second grid 3 are limited.

According to the radiation phase contrast image capturing system configured in the manner as described above, the distance Z₂ from first grid 2 to second grid 3 may be made smaller than the Talbot interference distance, so that the image capturing system may be made thinner in comparison with the radiation image capturing system of the first embodiment that ensures a certain Talbot interference distance.

Further, in the radiation phase contrast image capturing system of the embodiment described above, two grids, first grid 2 and second grid 3, are used but second grid 3 may be omitted by providing the function of second grid 3 in the radiation image detector. Hereinafter, a structure of a radiation image detector having the function of second grid 3 will be described.

The radiation image detector having the function of second grid 3 is a detector that detects a self image G1 of first grid 2 formed by first grid 2 when radiation is passed through first grid 2, and stores a charge signal according to the self image G1 in a charge storage layer divided into a grid pattern, to be described later, thereby intensity-modulating the self image G1 to generate a fringe image and outputting the fringe image as an image signal.

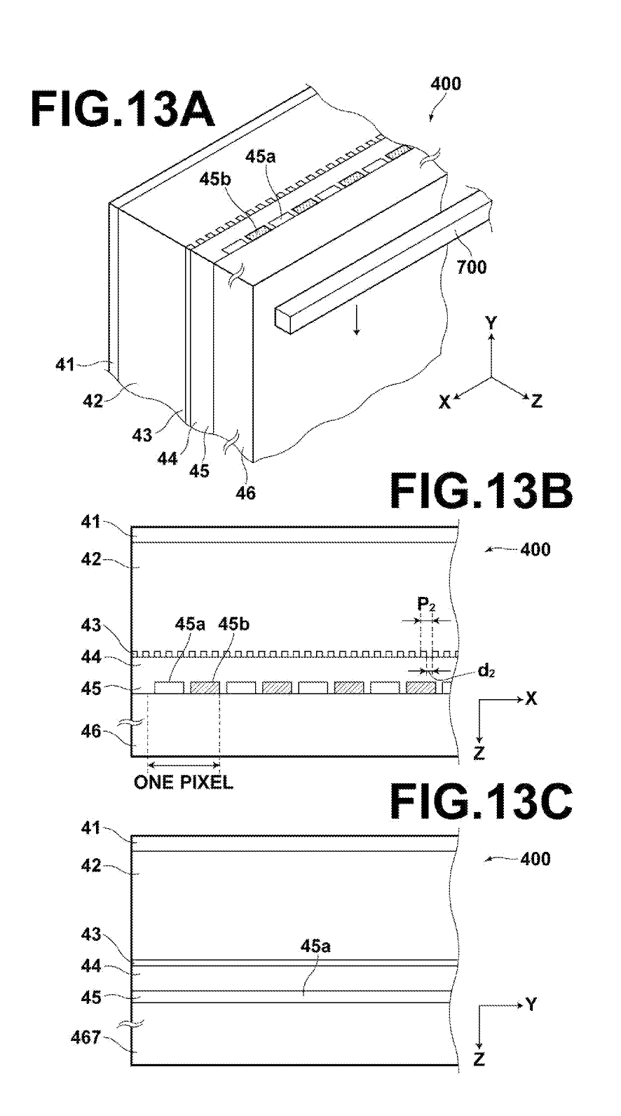

FIG. 13A is a perspective view of radiation image detector 400 having the function of second grid, FIG. 13B is an X-Z cross-sectional view of the radiation image detector shown in FIG. 13A, and FIG. 13C is a Y-Z cross-sectional view of the radiation image detector shown in FIG. 13A.

As illustrated in FIGS. 13A to 13C, radiation image detector 400 includes the following stacked on top of each other in the order listed below: first electrode layer 41 that transmits radiation; recording photoconductive layer 42 that generates electric charges by receiving radiation transmitted through first electrode layer 41; charge storage layer 43 that acts as an insulator against a charge of either polarity and as a conductor for a charge of the other polarity; readout photoconductive layer 44 that generates electric charges by receiving readout light; and second electrode layer 45. Each of the layers is stacked on glass substrate 46 from second electrode layer 45.

First electrode layer 41 may be made of any material as long as it transmits radiation. For example, a MESA film (SnO₂), ITO (Indium Tin Oxide), IZO (Indium Zinc Oxide), IDIXO (Indemitsu Indium X-metal Oxide, Idemitsu Kosan Co., Ltd.), which is an amorphous state transparent oxide film, or the like with a thickness in the range from around 50 to around 200 nm may be used Alternatively, Al or Au with a thickness of 100 nm may also be used.

Recording photoconductive layer 42 may be made of any material as long as it generates electric charges by receiving radiation. Here, a material which includes a-Se as the major component is used, since a-Se has superior properties including high quantum efficiency for radiation and high dark resistance. Preferably, the thickness of the recording photoconductive layer 42 is in the range from 10 μm to 1500 μm. For mammography application, the thickness is preferable to be in the range from 150 μm to 250 μm, while for general imaging application, the thickness is preferable to be in the range from 500 μm to 1200 μm.

Charge storage layer 43 may be any film as long as it is insulative to the polarity of electric charges desired to be stored, and may be made of acrylic organic resins, polymers, such as polyimide, BCB, PVA, acrylic, polyethylene, polycarbonate, and polyetherimide, sulfides, such as As₂S₃, Sb₂S₃, ZnS, and the like, in addition to oxides and fluorides. More preferably, charge storage layer 43 is made of a material which is insulative to the polarity of electric charges desired to be stored and conductive to the other polarity and has a triple-digit difference or more in the produce of mobility×operating life between the polarities of electric charges.

Preferable compounds include As₂Se₃, As₂Se₃ doped with 500 ppm to 2000 ppm of Cl, Br, or I, As₂(SexTe1-x)₃(0.5<x<1) prepared by substituting Se in As₂Se₃ with Te up to about 50%, As₂Se₃ in which Se is substituted with S up to about 50%, As₂Se_{y}(x+y=100, 34≦x≦46) prepared by changing the concentration of As in As₂Se₃ about ±15%, and an amorphous Se—Te system with 5 to 30 wt % of Te.

Preferably, a material having a dielectric constant of one half to twice of the dielectric constant of recording photoconductive layer 42 and readout photoconductive layer 44 is used for charge storage layer 43 in order not to bend electric lines of force formed between first electrode layer 41 and second electrode layer 45.

As illustrated in FIGS. 13A to 13C, charge storage layer 43 is divided linearly so as to be parallel with the extension direction of linear transparent electrode 45a and opaque liner electrode 45b of second electrode layer 45.

Charge storage layer 43 is divided with a finer pitch than that of linear transparent electrode 45a or linear opaque electrode 45b, and the condition of the arrangement pitch P₂ and distance d₂ is the same as that of second grid 3 in the embodiment described above.

Further, charge storage layer 43 is formed with a thickness of not greater than 2 μm in the stacking direction (Z direction).

Charge storage layer 43 may be formed by a resistance heating deposition process using one of the materials described above and a metal mask which is a metal plate with well-aligned apertures or a mask made of a fiber. Alternatively, charge storage layer 43 may be formed by photolithography.

Readout photoconductive layer 44 maybe made of any material as long as it shows electrical conductivity by receiving readout light. For example, photoconductive materials that consist mainly of at least one of the materials selected from the group consisting of a-Se, Se—Te, Se—As—Te, nonmetal phthalocyanine, metal phthalocyanine, MgPc (Magnesium phthalocyanie), VoPc (phase II of Vanadyl phthalocyanine), CuPc (Cupper phthalocyanine), and the like are preferably used. Preferably, the thickness of the readout photoconductive layer 44 is 5 to 20 μm.

Second electrode layer 45 includes a plurality of transparent linear electrodes 45a and a plurality of opaque linear electrodes 45b. Transparent linear electrodes 45a and opaque linear electrodes 45b extend linearly and continuously from one end to the other end of the image forming area of radiation image detector 400. As illustrated in FIGS. 13A and 13B, transparent linear electrodes 45a and opaque linear electrodes 45b are disposed alternately in parallel at a predetermined distance.

Transparent linear electrode 45a is made of an electrically conductive material that transmits the readout light. For example, ITO, IZO, or IDIXO may be used as in the first electrode layer 41. The thickness of transparent electrode 45a is 100 to 200 nm.

Opaque linear electrode 45b is made of an electrically conductive material that blocks the readout light. For example, a combination of one of the transparent conductive material and a color filter may be used. The thickness of the transparent conductive material is about 100 to 200 nm.

In radiation image detector 400, an image signal is read out using a pair of adjacent linear transparent electrode 45a and linear opaque electrode 45b, to be described later in detail. That is, as illustrated in FIG. 13B, an image signal of one pixel is read out by a pair of linear transparent electrode 45a and linear opaque electrode 45b. For example, linear transparent electrodes 45a and linear opaque electrodes may be arranged such that the size of one pixel becomes about 50 μm.

As illustrated in FIG. 13A, linear readout light source 700 extending in a direction (X direction) orthogonal to the extension direction of linear transparent electrodes 45a and linear opaque electrodes 45b is provided in cassette unit 17. Linear readout light source 700 includes a light source of LEDs (Light Emitting Diodes) or LDs (Laser Diodes) and a given optical system, and configured to emit linear readout light with a width in the extension directions (Y directions) of linear transparent electrodes 45a and linear opaque electrodes 45b of about 10 μm onto radiation image detector 400. Linear readout light source 700 is configured to be moved by a give moving mechanism (not shown) in Y directions, and radiation image detector 400 is scanned with the linear readout light emitted from the linear readout light source 700 by the movement, whereby image signals are read out.

The distance condition between first grid 2 and radiation image detector 400 to function as a Talbot interferometer is the same as that between first grid 2 and second grid 3 since radiation image detector 400 functions as second grid 3.

An operation of radiation image detector 400 configured in the manner as described above will now be described.

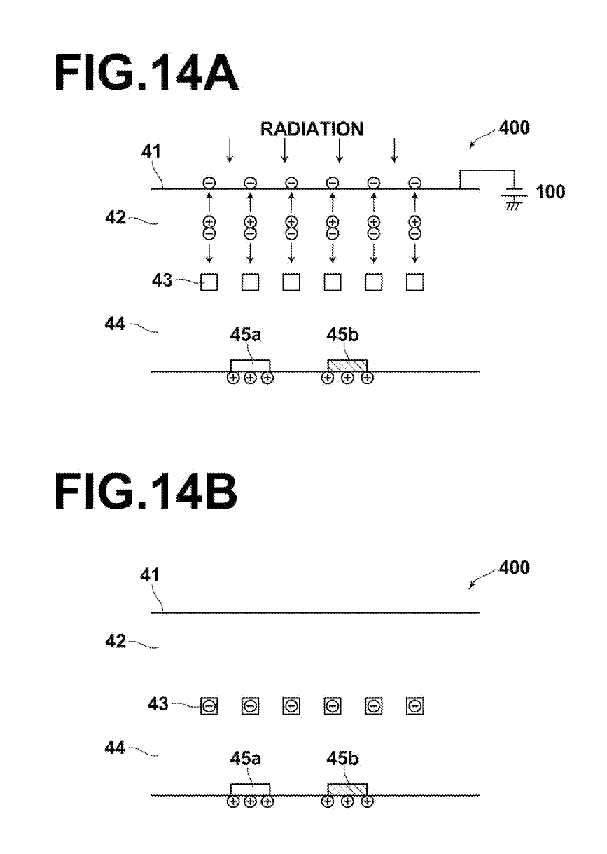

First, as shown in FIG. 14A, radiation representing a self image G1 of first grid 2 generated by Talbot effect is directed to radiation image detector 400 from the side of first electrode layer 41 with a negative voltage being applied to first electrode layer 41 of radiation image detector 400 from high voltage source 100.

The radiation incident on radiation image detector 400 transmits through first electrode layer 41 and reaches recording photoconductive layer 42. Then, electron-hole pairs are generated by the radiation. The positive electric charges of the electron-hole pairs are coupled with the negative electric charges charged on first electrode layer 41 and disappear, while the negative charges of the electron-hole pairs are stored in charge storage layer 43 as latent image charges (FIG. 14B).

As charge storage layer 43 is linearly divided with the aforementioned arrangement pitch, only some of the electric charges generated according to the self image G1 of first grid 2 in recording photoconductive layer 42 directly under which charge storage layers 43 are present may be trapped by and stored in charge storage layers 43 while the other electric charges pass through a gap between charge storage layers 43 (non-charge storage area) and flow out to linear transparent electrodes 45a and linear opaque electrodes 45b.

Storage of only some of the electric charges generated in recording photoconductive layer 42 directly under which charge storage layers 43 are present may result in that the self image G1 of first grid 2 is superimposed with the linear pattern of charge storage layers 43 and intensity-modulated, whereby an image signal of fringe image reflecting distortion of a wave-front of the self image G1 of first grid 2 due to the subject B is stored in charge storage layers 43. That is, charge storage layers 43 may provide a function equivalent to that of second grid 3.

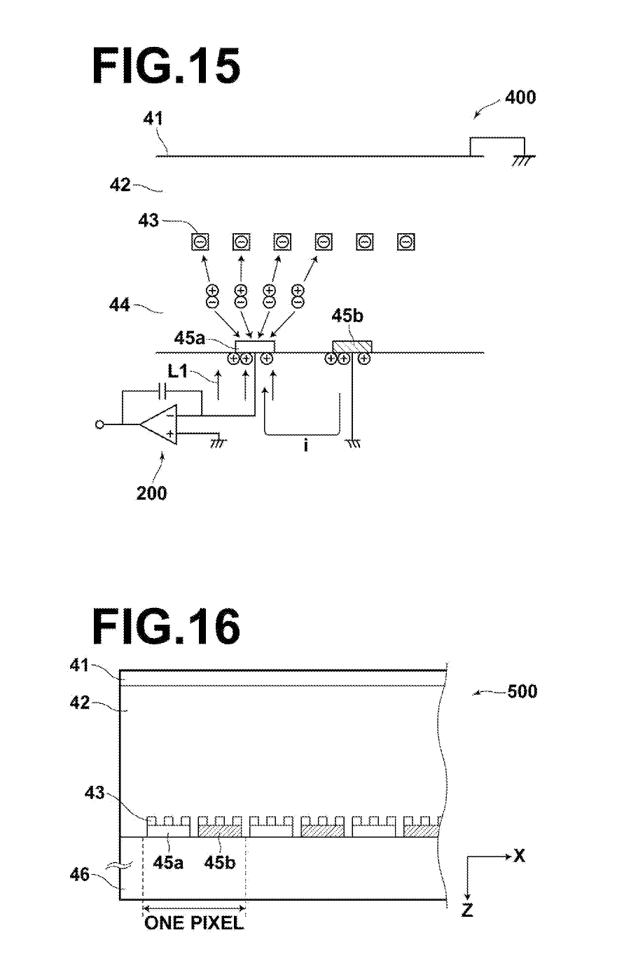

Next, as illustrated in FIG. 15, with the first electrode layer 41 being grounded, linear readout light L1 emitted from linear readout light source 700 is directed to radiation image detector 400 from the side of second electrode layer 45. The readout light L1 transmits through linear transparent electrodes 45a and reaches readout photoconductive layer 44. Then, positive electric charges generated in readout photoconductive layer 44 by the readout light L1 are coupled with the latent image charges stored in charge storage layers 43, while negative electric charges are coupled with positive electric charges charged on each of linear opaque electrodes 45b through a charge amplifier 200 connected to each of linear transparent electrodes 45a.

Then, the coupling of the negative charges generated in readout photoconductive layer 44 with the positive charges charged on each of linear opaque electrodes 45b causes an electric current to flow through each of charge amplifiers 200 and the electric currents are integrated and detected as an image signal.

Then, linear readout light source 700 is moved in the sub-scanning direction (Y direction) to scan radiation image detector 400 with the linear readout light L1, whereby image signals are sequentially detected with respect to each readout line illuminated by the linear readout light L1 and the detected image signals with respect to each readout line are sequentially inputted to image memory 35a and stored therein.

Thereafter, the entire surface of radiation image detector 400 is scanned with the readout light L1 and image signals of one frame are stored in image memory 35a.

Then, as second grid 3 is translated with respect to first grid 2 in the radiation phase contrast image capturing system of the embodiment described above, radiation image detector 400 having the function of second grid 3 is translated to obtain a plurality of radiation image signals. Note that a configuration may be adopted, wherein first grid 2 is translated instead of radiation image detector 400.

The operation after a plurality of radiation image signals constituting one phase contrast image is stored in image memory 35a is identical to that of the embodiment described above.

Although radiation image detector 400 having the function of second grid 3 includes three layers of recording photoconductive layer 42, charge storage layers 43, and readout photoconductive layer 44 between two electrode layers, but the layer structure is not necessarily limited to this and, for example, linear charge storage layers 43 maybe provided so as to directly contact linear transparent electrodes 45a and linear opaque electrodes 45b of second electrode layer 45 without providing readout photoconductive layer 44, and recording photoconductive layer 42 may be provided on charge storage layers 43, as illustrated in FIG. 16. Note that recording photoconductive layer 42 also functions as a readout photoconductive layer.

Radiation image detector 500 has a structure in which charge storage layers 43 are provided directly on second electrode layer 45, thereby allowing linear charge storage layers 43 to be formed easily. That is, linear charge storage layers 43 may be formed by deposition. In the deposition process, a metal mask or the like is used for selectively forming a linear pattern. The structure in which linear charge storage layers 43 are provided on readout photoconductive layer 44 requires handling in the air between the deposition process of readout photoconductive layer 44 and deposition process of recording photoconductive layer 42 for setting the metal mask after readout photoconductive layer 44 is deposited. This may cause degradation in readout photoconductive layer 44 or mixing of foreign object between the two photoconductive layers, resulting in quality degradation. The structure that does not provide readout photoconductive layer 44 may reduce handling time in the air and the concern of quality degradation described above may be reduced.

As for the materials of recording photoconductive layer 42 and charge storage layers 43, identical materials to those used in radiation image detector 400 may be used. The structure of charge storage layers 43 is also identical to that of the radiation image detector described above.

An operation of radiation image detector 500 for recording and reading of a radiation image will now be described.

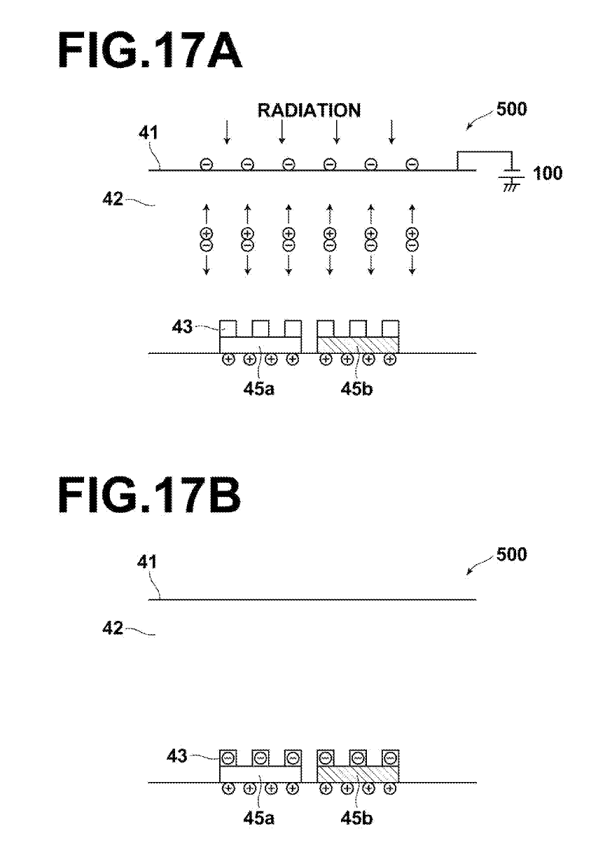

First, as shown in FIG. 17A, radiation representing a self image G1 of first grid 2 is directed to radiation image detector 500 from the side of first electrode layer 41 with a negative voltage being applied to first electrode layer 41 of radiation image detector 500 from high voltage source 100.

The radiation incident on radiation image detector 500 transmits through first electrode layer 41 and reaches recording photoconductive layer 42. Then, electron-hole pairs are generated by the radiation. The positive electric charges of the electron-hole pairs are coupled with the negative electric charges charged on first electrode layer 41 and disappear, while the negative charges of the electron-hole pairs are stored in charge storage layer 43 as latent image charges (FIG. 17B). As linear charge storage layers 43 contacting second electrode layer 45 is an insulating film, electric charges reached charge storage layers 43 are trapped and unable to move onto second electrode layer 45, whereby electric charges are accumulated thereat.

Here, as in radiation image detector 400 described above, storage of only some of the electric charges generated in recording photoconductive layer 42 directly under which charge storage layers 43 are present may result in that the self image G1 of first grid 2 is superimposed with the linear pattern of charge storage layers 43 and intensity-modulated, whereby an image signal of fringe image reflecting distortion of a wave-front of the self image G1 of first grid 2 due to the subject B is stored in charge storage layers 43.

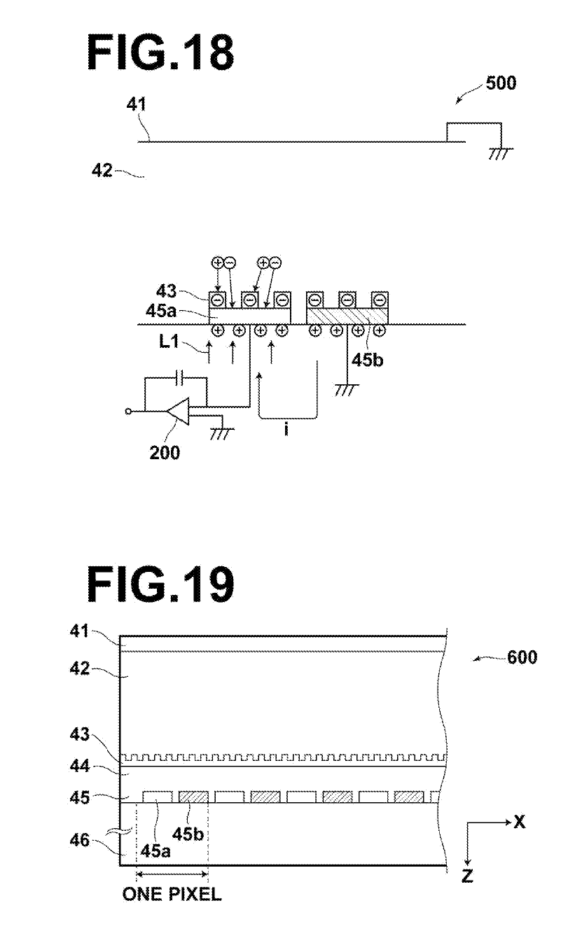

Next, as illustrated in FIG. 18, with the first electrode layer 41 being grounded, linear readout light L1 emitted from linear readout light source 700 is directed to radiation image detector 500 from the side of second electrode layer 45. The readout light L transmits through linear transparent electrodes 45a and reaches recording photoconductive layer 42 adjacent to charge storage layers 43. Then, positive electric charges generated by the readout light L1 are attracted to charge storage layers 43 and re-coupled, while negative electric charges are attracted to linear transparent electrodes 45a and coupled with positive electric charges charged on each of linear transparent electrode 45a and positive electric charges charged on each of linear opaque electrodes 45b through a charge amplifier 200 connected to each of linear transparent electrodes 45a. This causes electric currents to flow through each of charge amplifiers 200 and the electric currents are integrated and detected as an image signal.

In radiation image detectors 400 and 500 described above, charge storage layers 43 are formed as completely separate linear lines, but grid-like charge storage layers 43 may also be formed, for example, by forming a linear pattern on a plate as in radiation image detector 600 shown in FIG. 19.

In the embodiments described above, the description has been made of a case in which the radiation image capturing apparatus of the present invention is applied to a breast image capturing and display system. But the radiation image capturing apparatus of the present invention may also be applied to a radiation image capturing system that perform image capturing operation with a subject in the upright position, a radiation image capturing system that perform image capturing operation with a subject in the lateral position, a radiation image capturing system capable of performing image capturing operation with a subject in the upright position or in the lateral position, a radiation image capturing system that performs long length imaging, and the like.

Further, the present invention may also be applied to a radiation phase contrast CT system for obtaining a three-dimensional image, a stereoscopic imaging system for obtaining a stereoscopically viewable image, a tomosynthesis imaging system for obtaining a tomographic image, and the like.

In the embodiment described above, an image which has been difficult to be visualized can be obtained by obtaining a phase contrast image. As the conventional X-ray image diagnostics is based on absorption images, cross-referencing between absorption image and phase contrast image, if possible, is helpful for radiological image reading. For example, it is effective to compensate for a portion that can not be represented by an absorption image with information of a phase contrast image by superimposing the absorption image and phase contrast image on top of each other through appropriate processing, such as weighting, gradation processing, frequency processing, or the like.

But, separate imaging for an absorption image from that of a phase contrast image will result in difficulty in satisfactory superimposition of the images due to motion of the subject between imaging of the phase contrast image and imaging of the absorption image, as well as increased burden on the subject due to increased number of image capturing operations. Further, small angle scattering images have recently been drawing attention other than the phase contrast image and absorption image. The small angle scattering image may represent tissue characterization arising from a microstructure inside of a tissue of the subject, and hence it is expected as a new representation method for image diagnosis in the fields of cancer, circulatory disease, and the like.

As such, an absorption image generation unit for generating an absorption image or a small angle scattering image generation unit for generating a small angle scattering image from a plurality of cassette compensated fringe images obtained for generating a phase contrast image may further be provided in computer 30.

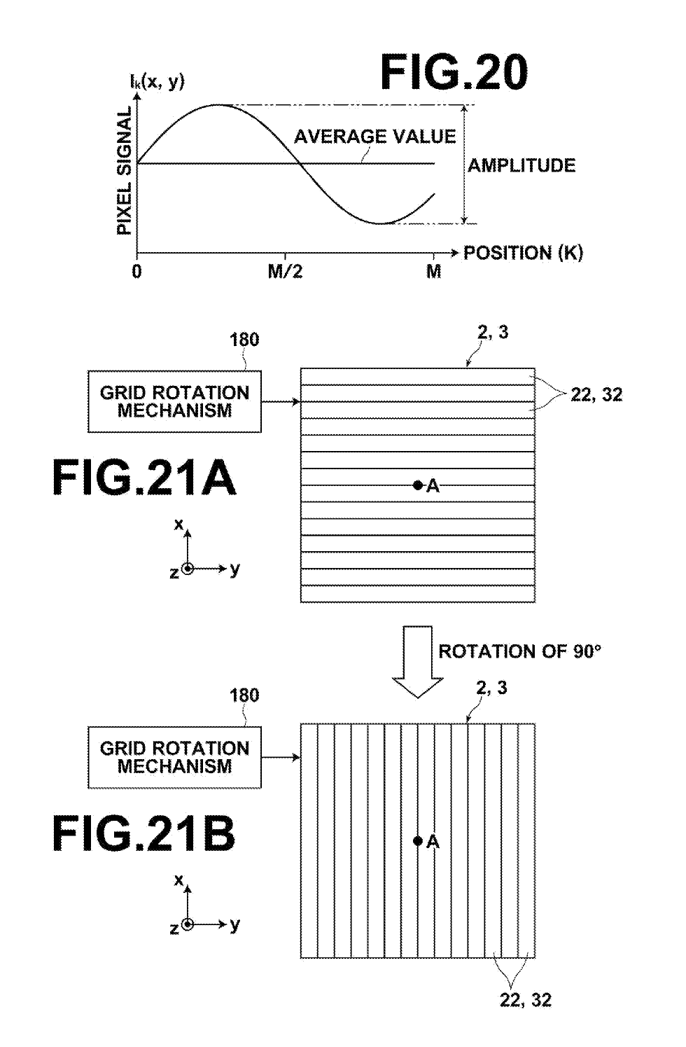

The absorption image generation unit generates an absorption image by averaging pixel signals Ik(x, y) obtained from each pixel with respect to k to obtain an average value, as illustrated in FIG. 20, and forming an image. The calculation of the average value may be performed by simply averaging the pixel signals Ik(x, y), but if the value of M is small, a larger error may result. If such is the case, pixel signals Ik(x, y) may be fitted with a sine wave and the average value of the sine wave may be obtained. Further, a rectangular wave or a triangular wave may also be used other than the sine wave.

The generation of an absorption image is not limited to the average value, and an added-up value, if it corresponds to the average value, obtained by adding the pixel signals Ik(x, y) with respect to k or the like may be used.

The small angle scattering image generation unit generates a small angle scattering image by calculating amplitude values of pixel signals Ik(x, y) obtained from each pixel and forming an image. The calculation of the amplitude value may be performed by obtaining a difference between maximum and minimum values of pixel signals Ik(x, y), but if the value of M is small, a larger error may result. If such is the case, pixel signals Ik(x, y) may be fitted with a sine wave and the amplitude value of the sine wave may be obtained. Further, a variance or a standard deviation may be used as the amount corresponding to the dispersion centered on the average value in the small angle scattering image generation other than the amplitude value.

Further, the phase contrast image is based on a refraction component of X-ray in the periodic arrangement direction (X direction) of members 22, 32 of first and second grids 2, 3 and a refraction component in the extension direction of members 22, 32 is not reflected in the image. That is, a region contour along a direction intersecting with X direction (Y direction if intersecting at right angle) is visualized as the phase contrast image based on the refraction component in X direction and a region contour along X direction without intersecting with X direction is not visualized as the phase contrast image. That is, a region of a subject which is not visualized may exist depending on the shape or orientation thereof. For example, if the direction of the weight bearing plane of a joint cartilage of a knee or the like is aligned with Y direction of XY directions, which are in-plane directions of the grids, a region contour adjacent to the weight bearing plane (YZ plane) substantially along Y direction is visualized satisfactorily, but a cartilage surrounding tissue (tendon or ligament) extending substantially along X direction may be insufficiently visualized. It may be possible to perform an image capturing operation again for the insufficiently visualized region by moving the subject, but this might increase the burden for both the subject and radiological technologist as well as posing a problem that it is difficult to ensure the position reproducibility for the image obtained by the second image capturing operation.

Consequently, as another example shown in FIG. 21, it is also advantageous to provide rotation mechanism 180 in grid unit 16 for rotating first and second grids 2, 3 centered on an imaginary line (optical axis A of X-ray) perpendicular to the center of the grid surfaces of first and second grids 2, 3 by a given angle from a first orientation shown in A of FIG. 21 to a second orientation shown in B of FIG. 21, thereby generating a phase contrast image at each of the first and second orientations.

This may eliminate the problem of position reproducibility. A of FIG. 21 shows the first orientation of first and second grids 2, 3 in which the extension direction of members 32 of second grid 3 corresponds to Y direction, while B of FIG. 21 shows the second orientation of first and second grids 2, 3 in which first and second grids 2, 3 are rotated by 90 degrees from the first orientation shown in A of FIG. 21 and the extension direction of members 32 of second grid 3 corresponds to X direction. But, first and second grids 2, 3 may be arbitrarily rotated if the inclination relationship between first grid 2 and second grid 3 is maintained. Further, an arrangement may be adopted in which the rotating operation is performed two or more times to orient first and second grids 2, 3 to third and fourth orientations in addition to the first and second orientations, and a phase contrast image is generated at each of the orientations.

Further, instead of rotating first and second grids 2, 3 which are one-dimensional grid, first and second grids 2, 3 may be formed as two-dimensional grids in which members 22, 32 are extended two-dimensional directions respectively.

This may minimize the influence of body motion and equipment vibration between image capturing operations as phase contrast images with respect to the first and second directions may be obtained by one image capturing operation, whereby better position reproducibility between the phase contrast images with respect to the first and second directions may be obtained in comparison with the case in which one-dimensional grids are rotated. Further, the rotation mechanism is not required, thereby resulting in a simplified system and reduced cost.

In the case where phase contrast images are generated in two or more directions in the manner described above, all of radiation image signals required for reconstructing phase contrast images in two or more directions may be associated with each other and stored in image memory 35a, and then these image signals may be transmitted to console 70 at a time. Alternatively, each time radiation image signals required for reconstructing a phase contrast image in each direction are associated and stored in image memory 35a, these image signals may be transmitted to console 70 at a time.

What is claimed is:

1. A radiation image capturing apparatus which comprises: a first grid provided with grid structures disposed at intervals and forms a first periodic pattern image by passing radiation emitted from a radiation source; a second grid that receives the first periodic pattern image and forms a second periodic pattern image; a radiation image detector that detects the second periodic pattern image formed by the second grid; and a scanning mechanism that moves at least one of the first and second grids in a direction orthogonal to an extension direction of the one of the grids, and which obtains radiation image signals representing a plurality of second periodic pattern images detected by the radiation image detector at each position of the one of the grids along with the movement by the scanning mechanism,
wherein the apparatus further comprises:
a storage unit for storing the plurality of radiation image signals;
an association unit for associating the plurality of radiation image signals stored in the storage unit; and
a communication unit for transmitting one set of the radiation image signals associated by the association unit at a time.

2. The radiation image capturing apparatus of claim 1, wherein the apparatus comprises a cassette in which the radiation image detector, the storage unit, and the communication unit are accommodated and the cassette is configured to be removably attachable.

3. The radiation image capturing apparatus of claim 1, wherein:
the apparatus comprises a partial radiation image signal obtaining unit that obtains a radiation image signal in a partial area of each radiation image signal stored in the storage unit;
the association unit is a unit that associates each radiation image signal in the partial area; and
the communication unit is a unit that transmits one set of the associated radiation image signals in the partial area at a time.

4. The radiation image capturing apparatus of claim 3, wherein the partial area is a region of interest.

5. The radiation image capturing apparatus of claim 4, wherein:
the apparatus comprises a compression processing unit that performs compression processing on the plurality of radiation image signals;
the association unit is a unit that associates the compression processed radiation image signals; and
the communication unit is a unit that transmits one set of the compression processed radiation image signals associated by the association unit at a time.

6. The radiation image capturing apparatus of claim 3, wherein:
the apparatus includes a compression processing unit that performs compression processing on the plurality of radiation image signals in the partial area;
the association unit is a unit that associates the compression processed radiation image signals; and
the communication unit is a unit that transmits one set of the compression processed radiation image signals associated by the association unit at a time.

7. The radiation image capturing apparatus of claim 1, wherein the association unit is a unit that performs association processing based on header information of each radiation image signal.

8. The radiation image capturing apparatus of claim 7, wherein the association unit is a unit that performs the association processing based on patient information included in the header information of each radiation image signal.

9. The radiation image capturing apparatus of claim 1, wherein the communication unit is a unit that performs wireless communication.

10. A radiation image obtaining method which uses a radiation image capturing apparatus, including: a first grid provided with grid structures disposed at intervals and forms a first periodic pattern image by passing radiation emitted from a radiation source; a second grid that receives the first periodic pattern image and forms a second periodic pattern image; a radiation image detector that detects the second periodic pattern image formed by the second grid; and a scanning mechanism that moves at least one of the first and second grids in a direction orthogonal to an extension direction of the one of the grids, and which obtains radiation image signals representing a plurality of second periodic pattern images detected by the radiation image detector at each position of the one of the grids along with the movement by the scanning mechanism, the method comprising the steps of:
storing the plurality of radiation image signals and associating the plurality of stored radiation images; and
transmitting one set of the associated radiation image signals at a time.
